(19) United States
(12) Patent Application Publication
(10) Pub. No.: US 2002/0042885 A1
(43) Pub. Date: Apr. 11, 2002

(54) Method, process and apparatus for receiving, storing and accessing authorization data

(76) Inventor: Raffie Eskandarian, Santa Monica, CA (US)

Correspondence Address: Brull, Piccionell, Sarno,, Braun & Vradenburgh, Suite 2350, 1925 Century Park East, Los Angeles, CA, 90067, US

(21) Appl. No.: 09/912,764

(22) Filed: Jul. 25, 2001

Related U.S. Application Data
(60) Provisional application No. 60/227,095, filed on Aug. 22, 2000.

(51) Int. Cl. G06F 11/30

(52) U.S. Cl. 713/201

(57) ABSTRACT

Embodiments of the present invention are directed to a method and apparatus for a data input, storage and retrieval system for obtaining and storing authorization data. Embodiments of the data comprise a data receiving member, a storage database and a retrieval mechanism. The data receiving member further comprises an input device and a data processor. The input device is any standard computer input device, such as, a mouse, which controls a pointer or cursor that traverses the computer display and allows the user to move within a data file. The data processor comprises an applet and processing script, wherein the applet configures an input pad on the user's display. The input pad is accessible to the user via the input device, and can be used to sign signature indicia within the input pad. After the signature has been input and submitted, the signature data is processed. After the input data has been processed, the processing script receives the input data and stores the data in a storage database in conjunction with a unique code for later retrieval.

### RELATED APPLICATIONS

This application claims priority from provisional patent application, Ser. No. 60/227,095 filed Aug. 22, 2000, entitled “Method, Process And Apparatus For Receiving And Storing Pixel Coordinate Data From A Peripheral Computer Device”, which is fully incorporated herein by reference.

### FIELD OF THE INVENTION

Embodiments of the present invention are directed to a method and apparatus for a data input, storage and retrieval system for obtaining and storing authorization data, such as a signature, from a consumer prior to the completion of a transaction. More specifically, embodiments of the present invention are directed to an apparatus and process for inputting and storing a user signature via the user's computer screen and a mouse.

### BACKGROUND OF THE DISCLOSURE

Global or wide area networks, such as the World Wide Web (“WWW”) or Internet, provide a platform for users, irregardless of location, to transact business. Indeed, in addition to general information, wide area networks have provided information regarding the availability of a wide variety of products and services, which are for sale.

As is generally understood, products and services can be offered from providers or merchants from a provider computer via a web site or web pages. To access and view information, users utilize a user computer having a browser, that is, a computer program which enables the user to view information or files communicated over the network. Typically, pages of content, or web sites, which are accessible via networks, are written in Hypertext Markup Language (HTML), wherein HTML is a standard page description language.

In the instance of the purchase of a product or services, consumers that purchase merchandise or services on the network present credit card and payment information to an on-line merchant via a user computer. The user computer, via the browser software, transmits the purchase request and payment information to the provider or merchant computer over a communications network. Typically, the information is processed and the card account is debited the purchase amount.

In most purchase transactions utilizing a credit card on a network, no signature for the purchase is delivered to the merchant for the use of the card. Transactions on a network fall into a category known as mail order/telephone order transactions (“MO/TO”). One problem with the current modality of paying for items and services via a credit card for MO/TO transactions is that these transactions are easily disputed by the consumer. Indeed, without the consumer's signature on a credit slip, most credit card companies simply issue a refund with no investigation as to whether services were indeed provided, or whether a product was delivered. As such, the charge is “charged back” to the merchant.

These refunds to the consumer are commonly referred to as charge backs. Currently, charge backs are becoming an increasing problem with respect to transactions on the WWW, and thus, becoming problematic for merchants. Indeed, banks will charge a merchant a charge back fee for the refund, in addition to the amount of the refund. As the number of charge backs charged to a merchant's account increases, the merchant is subject to an increasing risk of losing the merchant account. Indeed, if the charge back ratio exceeds a predefined percentage, the charge back fees are increased and ultimately, the merchant can lose the account. If a merchant loses the merchant account, the merchant cannot transact credit card payments, and thus, virtually all transactions on the WWW would be unavailable to the merchant.

In light of the increasing penalties for high charge back rates, the minimization of charge backs have become of paramount importance for merchants transacting business on the WWW. In addition to the issue of credit card transactions, other transactions are occurring on networks, such as, the entering into and signing of contracts. These transactions would also benefit from the use of an actual signature.

One attempt at solving the lack of signatures in electronic transactions is the use of a pen and digitizer system which allows for data entry. The pen and digitizer system allows a user to sign on an external pad with a special pen, wherein the pad is coupled to the computer and is in electronic communication with the computer. In this manner, the signature data is transmitted into the computer and is associated with the transaction currently being presented to the user via the computer. The pen is exclusively used with the external pad, and neither the pen nor pad provide any other use for typical computer functions.

Although the digitizer and pen system allows for the capturing of a signature in connection with the transaction, due to the very specialized function of the digitizer system, the system requires additional hardware and software. Indeed, the digitizer and pen system requires additional software that is specifically capable of communicating with the additional hardware, namely, the digitizer pad. Thus, to utilize the system, even if made available for use by the provider, a user is required to purchase and install additional equipment and software, thereby increasing the cost of the transaction for the user and decreasing the likelihood that the digitizer and pen system could always be used.

In addition to the digitizer and pen system, other available systems also require the application to be installed and executed on the particular platform of the user. Such systems are suitable for digital signatures obtained when person is present where the application is residing. For example, a store owner opting to accept signatures in digital format may install this application and execute it on the cashier computer. These systems are known as a client-based application (i.e., client application), where the end user and/or the operator is required to perform certain steps on location of the application in order for the application to perform. Indeed, without the pen/digitizer pad hardware, or PCMCIA cards in certain cases, these other systems would not function.

A need in the industry exists for the capability of the merchant to receive a verification or authorization, such as a signature, from the consumer prior to the completion of the transaction without the requirements for the purchase and installation of additional hardware and software by the user. A further need exists for a system that is not dependent upon any particular hardware, and further, can be utilized irregardless of the computer or the operating system. A further need exists for a system and process that allows the merchant to provide evidence of the previously obtained consumer authorization in the instance that the charge is disputed by the consumer.

### SUMMARY OF THE DISCLOSURE

Embodiments of the present invention are directed to a method and apparatus for a data input, storage and retrieval system for obtaining and storing authorization data, such as a signature, from a consumer prior to the completion of a transaction. Embodiments of the present invention allow the inputting and storage of a user signature via the user's computer screen and a mouse, wherein the document being signed presents the signature option to the user.

Embodiments of the present invention comprise a data receiving member, a storage database and a retrieval mechanism. The data receiving member further comprises an input device and a data processor.

The input device is any standard computer input device, such as, a mouse. The input device controls a pointer or cursor that traverses the computer display and allows the user to move within a file.

The data processor processes the data input from the input device. The data processor comprises an applet and processing script. The applet is a software module that is adaptable and integrates with standard network software. Thus, a user need not install any additional software, but rather, can access the applet as it is presented to the user.

The applet configures an input pad on the user's display. The input pad is accessible to the user via the input device, wherein the user need only place the cursor or pointer inside the input pad with the input device. The user can then utilize the input device to sign a signature indicia within the input pad. If the signature is acceptable to the user, the user can submit the signature via a submit button. If the user is not satisfied with the signature, the user can clear the input pad via a clear button, and resign his name.

After the signature has been input and submitted, the signature data is processed. If necessary, the input signature data is smoothed by a fitting algorithm. Once smoothed, the input data is compressed and formatted into a bitmap. In some instances, no fitting algorithm is utilized.

After the input data has been compressed, or otherwise processed, the processing script receives the input data and stores the data in a storage database in conjunction with a unique code. In this manner the signature can be retrieved via the unique code if a dispute arises with regard to the authorization of the transaction.

A feature of preferred embodiments of this invention is that merchants can easily utilize the on-line signature pad as only a slight modification to preexisting HTML code is required to implement the system. An advantage to this feature is that no new software is required to implement this system as it only requires slight modifications to existing software.

A further feature of preferred embodiments of this invention is that users can easily utilize the on-line signature pad as only a browser that supports HTML language and a JAVA applet is required. An advantage to this feature is that no new software is required to implement this system as it utilizes existing software and software that is supported by existing software, thereby eliminating the requirement to download or purchase any new software.

A still further feature of preferred embodiments of this invention is that it operates in conjunction with any standard browser that supports standard HTML and a standard mouse input device. An advantage to this feature is that, unlike other digital signature methods that utilize additional hardware devices, such as, electronic pens, digitizer pad, PCMCIA cards and the like, embodiments of the present invention do not require the user to obtain additional software or hardware to operate the system.

A still further feature of preferred embodiments of the present invention is that end users need not download, install, or execute any software or application to use the signature acceptance module. An advantage to this feature is that the end users can visit any web site, that is, url or domain name via World Wide Web, that utilizes the present system, and enter their signature on the site itself Another advantage to this feature is that the present system can be utilized anywhere from any wide area network connection in the world.

A still further feature of preferred embodiments of this invention is that the input device is a mouse. An advantage to this feature is that no additional equipment is required to operate or implement this system, thereby allowing merchants to introduce the system without affecting their sales or transaction ability.

A further feature of preferred embodiments is that web site operators desiring to accept signatures via a network can easily modify their website by inserting a few lines of code into the HTML of the website. An advantage to this feature is that the signature acceptance section can be integrated onto the website and enables the web site operator to accept user's signatures without any additional user hardware or software requirements.

A still further feature of preferred embodiments is that it utilizes a ‘smoothing’ algorithm to assist in forming a more accurate signature. An advantage to this feature is that the user's computer signature more accurately reflects a user's “real” signature.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 is a diagram of a data input, storage and retrieval system for obtaining and storing authorization data in accordance with a preferred embodiment.

FIG. 3 is an illustrative diagram of an input pad in accordance with the embodiment of FIG. 2.

FIG. 4 is a schematic representation of a method of a smoothing algarithm in accordance with preferred embodiments of the present invention.

FIG. 5 is a data input, storage and retrieval method in accordance with a preferred embodiment.

FIG. 6 is a flowchart illustrating user interaction in accordance the preferred embodiment of FIG. 5.

FIG. 7 depicts a transaction page having a data receiving pad in accordance with the preferred embodiment of FIG. 5.

FIG. 8 is a two dimensional view of a device in accordance with another preferred embodiment.

### DETAILED DESCRIPTION OF THE PREFERRED EMBODIMENTS

Preferred embodiments of the instant invention operate in accordance with a computer network and facilitates the receipt, processing and retrieval of user authorization indicia.

Hardware Environment

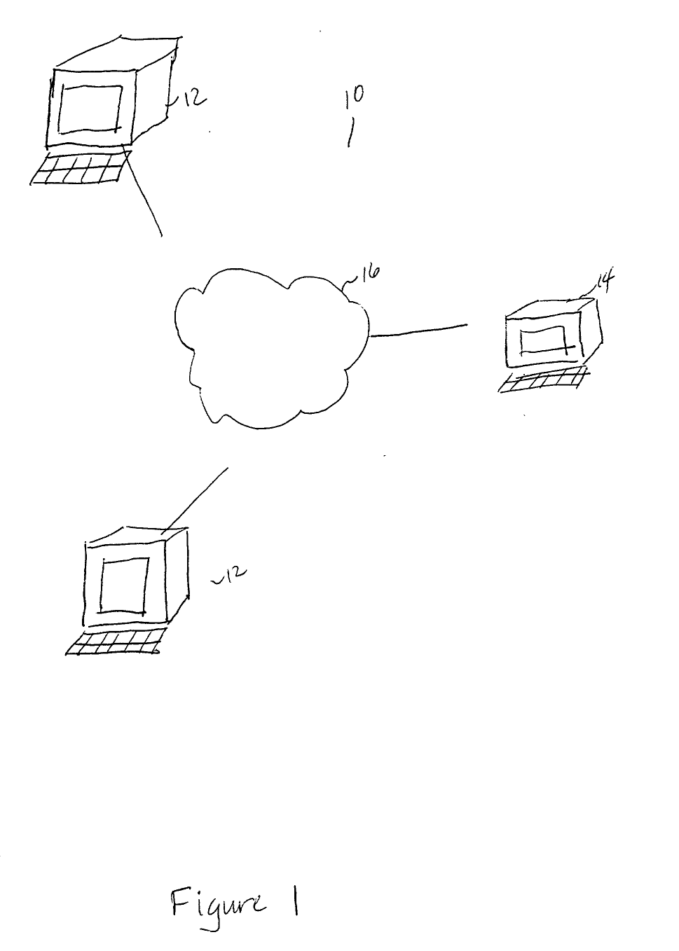

Preferred embodiments of the instant invention operate with a network comprising a plurality of networked computers, such as, for example, at least one user computer and at least one provider computer which are coupled together in a communications network, such as, for example, the Internet or WWW. FIG. 1 depicts a simplified representation of an example network system 10 that is operated in accordance with preferred embodiments of the invention.

The network system 10 includes at least one client or user computer 12 and at least one content provider or server computer 14 coupled for communication therebetween, generally represented at 16. In the illustrated embodiment, two client or user computers 12 and one content provider computer 14 are shown in the network system. It will be understood that further embodiments may employ any suitable number of user and provider computers. The network system 10 may comprise a closed or intranet configuration, an open or public-access network configuration or combinations of such configurations, as is well known in the art. For purposes of simplifying the present disclosure, the various hardware components (for example, host servers, routers, connectors) and software necessary for communication between computers on the network system are not described herein in detail. Such hardware and software are well within the scope of one of ordinary skill in the art and are at least partially dependent upon the type of network system employed and the desired application of use.

The user computer 12 may comprise any suitable network device capable of communicating with other network devices in the network system. In preferred embodiments, the user computer comprises a programmable processor capable of operating in accordance with programs stored on one or more computer readable media 18, a display device 20 for providing a user-perceivable display, and a user input device 22, for example, but not limited to, a keyboard, mouse, microphone, or the like. In one preferred embodiment, the user computer comprises a personal computer system having a CRT display, a keyboard and a mouse user-input device.

The user computer 12 is controlled by suitable software, including network communication and browser software to allow a user to request, receive and display information (or content) from or through a content provider computer 14 on the network system 10. In preferred embodiments, the user computer 12 employs a program, such as a browser, for displaying content received from a provider computer 14.

The content provider computer 14 may comprise any suitable network device capable of providing content (data representing text, hypertext, photographs, graphics video and/or audio) for communication over the network. In preferred embodiments, the provider computer comprises a programmable processor capable of operating in accordance with programs stored on one or more computer readable media 24 to provide content for communication to a user computer 12. The provider computer may comprise, for example, but not limited to, a personal computer, a mainframe computer, or the like. The provider computer 14 may include one or more internal data storage devices (not shown) for storing content for communication to a user computer 12. Alternatively, or in addition, the provider computer 14 may be coupled to an external data storage device, computer or other means, generally represented at 26, from which the provider computer 14 may obtain content for communication to a user computer 12. In one embodiment, the external device 26 may comprise a further network device coupled in the network 16.

The content provider computer 14 is controlled by suitable software to provide the requested content to the requesting user computer 12. In a preferred network environment, the content provider computer 14 is controlled by suitable software to respond to a valid request for content by providing (or downloading) data in the form of one or more HTML files to the user computer 12 from which the request was made. It will be understood by those skilled in the art that this process involves communications through suitable servers, routers and other components, as is dictated by the particular network environment. The HTML file(s) correspond to one or more HTML frames which, in conjunction with the browser software at the user computer 12, is displayable on the display device at the user computer as text, hypertext, photographs, graphics, sound, or the like, in a form that is perceivable to the user.

General Description of Preferred Embodiments

Embodiments of the present invention are directed to a method and apparatus for a data input, storage and retrieval system for obtaining, storing and retrieving authorization data, such as a signature, from a consumer prior to the completion of a transaction, or upon the acceptance of a transaction. In preferred embodiments, the evidence of the authorization is stored such that it can be retrieved and presented if the transaction is disputed or otherwise challenged. In particular, embodiments of the present invention are directed to an apparatus and process for inputting and storing a user signature via the user's computer screen and a mouse.

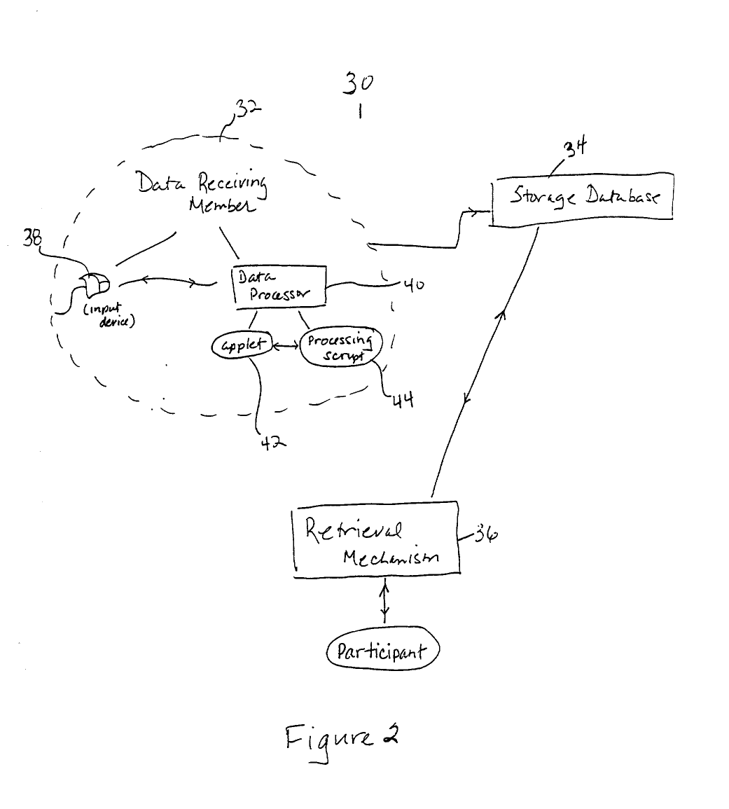

With reference to FIG. 2, embodiments of the data input, storage and retrieval system 30 operate on network having a participating or provider computer, and a user computer, wherein the user computer includes a display device and a pointer, or cursor, that defines locations on the display device. Preferred embodiments of the data input, storage and retrieval system 30 comprise a data receiving member 32, a storage database 34 and a retrieval mechanism 36. The data receiving member 32 further comprises an input device 38 and a data processor 40, wherein the input device and the data processor are in electronic communication. The input device 38 is any device capable of transmitting information into a computer processor. The input device 38 is configured to control the pointer, including moving the pointer in a continuous path on the display device. In preferred embodiments, the input device is a computer peripheral, including, but not limited to, a mouse.

The data processor is a software module that is capable of receiving and processing input data from the input device. In one preferred embodiment, the data processor comprises an applet 42 and a processing script 44.

The applet is software that is capable of operating in a network environment, such as, the software used for a network environment, such as the WWV. The applet software integrates with preexisting software as is currently used on networks by users and providers, and thus, does not require additional software or hardware. As such, no additional computer equipment is required to operate within the applet. Indeed, in this instance, the only required hardware is the mouse device that is a part of the standard computer equipment.

In preferred embodiments, the applet is integrated within an HTML frame or page by the participant for providing interaction with the HTML frame data. In typical network transactions, the HTML frame page is downloaded from the participating computer 14 to the user computer 12. Thus, the participant is capable of integrating the applet within the HTML page and presenting it to the user without requiring the user to download additional software or purchase additional hardware.

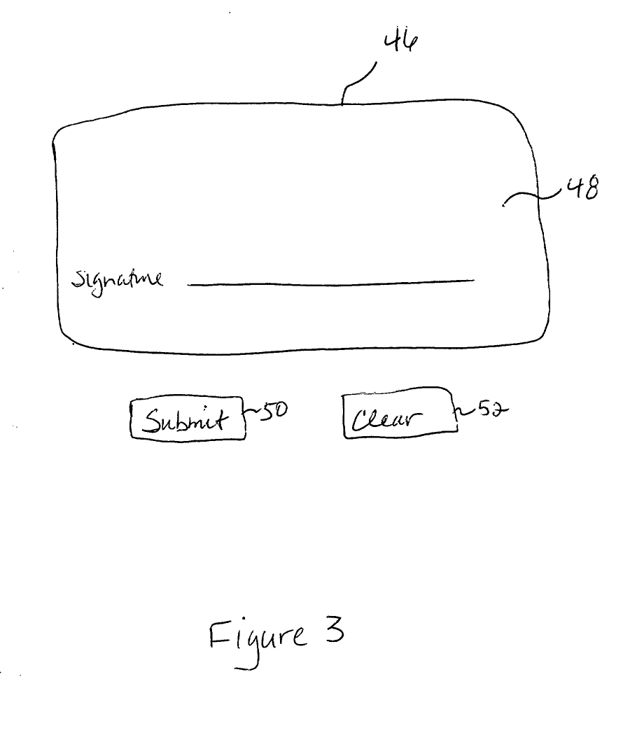

In preferred embodiments, the applet configures an input pad 46. In one preferred embodiment, the applet is a Java applet. With reference to FIG. 3, the input pad comprises a data receiving region 48, a submit button 50 and a clear button 52. The data receiving region 48 is a predefined area that is capable of receiving input data. The data receiving region 48 is defined by a matrix grid, wherein the structure of the grid is defined by pixel coordinates which are stored in the Java applet, for example, as a matrix database. The submit button 50 allows the user to transmit the information entered into the data receiving region 48 and the clear button 52 allows the user to erase and reenter information. For instance, a user dissatisfied with his signature can clear the signature and resign.

In addition to allowing the user to re-enter his signature, e.g., to correct for “jerky” or jagged portions of the signature, a fitting algorithm is applied to the input signature data to effectively “smooth” the signature and more accurately reflect the user's true signature. The interpretation of the signature data is accomplished via a software module written in Java and C++ languages. It is to be understood that the system is not limited to Java or C++, but rather, can include, although it is not limited to, operating in conjunction with Sun Microsystems JAVA, C/C++, Macromedia Flash and Macromedia Shockwave.

Overall, the signature comprises a plurality of adjacent segments, wherein each segment comprises at least two vertices. The vertices in the signature are determined by a predetermined amount of tolerable directional change at a point in the signature, for example, the top point of a cursive “s”. In this manner, the segments of the signature are determined by dividing the signature at points where in the directional change of the lettering exceeds the predefined tolerance.

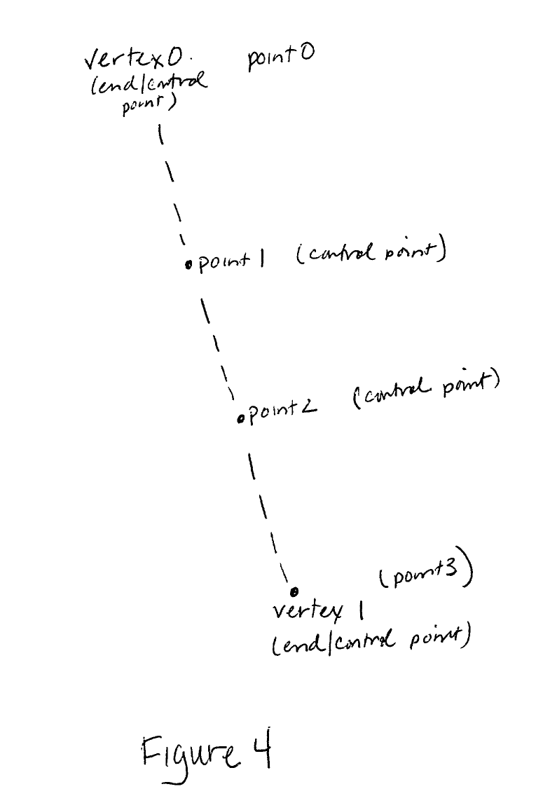

With reference to FIG. 4, as the signature is segmented, each segment comprises two vertices, or border points. Further, control points are identified between each of the vertices of the segments, wherein the distance between the control points is predefined and reflects the fitting criteria preset by the system. In one preferred embodiment, the fitting algorithm is based on the use of Bezier curves, wherein a maximum error between the curve and segment is predefined and which is based, in part, on the predefined tolerable distance between the control points.

When determining the Bezier curve, if the maximum error is exceeded, a redetermination of the placement of the control points is made in an attempt to reduce the error. In one preferred embodiment, a Newton-Raphson method is applied to determine more appropriate roots, and thereby reparameterizes the curve. The Newton-Raphson method is well known by those skilled in the art and is used to solve F(x)=0 by the iterative process: Xn+1=Xn−F(Xn)/F′(Xn), wherein Xn is the current known x-value, F(Xn) represents the value of the function at Xn, and F′(Xn) is the derivative (slope) at Xn. Xn+1 represents the subsequent x-value. The iteration is applied to the segments until the error is within the tolerable range, or the number of iteration steps becomes greater than a predefined number of steps. In this manner, infinite adjustment of the curve is avoided.

Although the system has been described utilizing two vertices per segment, in some preferred embodiments, more than two vertices are included in a segment. Typically, these segments already closely approximate a line or curve as desired. In these instances, to determine the control points, a tangent vector is utilized at the ends of the segments and a least-squares algorithm is applied to determine the control points. These techniques are more fully described in various text books. If this technique does not provide an appropriate curve, the segment is further divided and the above described fitting algorithms are applied to each of the portions of the divided segment.

As stated above, once the user is satisfied with the authorization data, the user depresses the submit button. Upon submission of the authorization data, the applet records the data entered into each pixel coordinate of the grid, wherein the value of the grid point is determined by the user's signature. A one to one correspondence exists between each point in the user's signature data and the pixel coordinates of the data receiving region upon which the data are deposited. Thus, a user's signature which is entered into the data receiving region 48 is defined by the value of the pixel coordinates which is recorded into a database. Where no signature data exists, a zero or null value is placed in the pixel coordinate corresponding to that grid point. As the data receiving region 48 reflects a matrix grid, it is irrelevant where the pointer is initially placed as the data is associated with the pixel coordinate corresponding to the pointer's location within the data receiving region 48 that is, the pointer's location within the matrix grid. Indeed, upon the placement of the input device 38 within the matrix grid, the coordinates of the input device 38 are recalculated into coordinates of the matrix grid.

In addition to identifying the value of the pixel coordinates for the signature, the applet records a variety of information for the transaction, including the time and date of the transaction. In one preferred embodiment, the applet ascertains parameter data, including, but not limited to, the following:

| | |
|---|---|
| PARTICIPANT_ID | Number assigned when the participant opens an |
| | account for the applet transaction |
| SIGN_WIDTH | The specified maximum width of data input, e.g., |
| | user's signature |
| SIGN_HEIGHT | The specified maximum height of data input, e.g., |
| | user's signature |
| BACK_COLOR | The applet's background color |
| SIGN_COLOR | The color used for the data input, e.g., signature |
| SIGN_VERIFY | Check if data input, e.g., user's signature, is too |
| | small, that is, there are only a few dots |
| FORM_NAME | The HTML tag name of the form to which the pad |
| | applet will be attached |
| FORM_FIELDS | Total number of form fields participant wants the |
| | system to store in addition to input data |
| FIELD1 | The first form field, such as user's name |
| FIELD2 | The second form field, such as user's email address |
| . . . | Remaining form fields |
| FIELDN | The final form field |

Upon presentation to the user of the information page, the participant's applet account information, including the participant's identification, is accessed by the system. In addition, the identification of the data which is to be correlated with the signature input data is retrieved from the account information. In this manner, values for FIELD 1, FIELD2 . . . FIELDN can be entered.

Once the grid data is recorded by the applet, the applet performs a compression routine or procedure and converts the input data into a digital bitmap image. The compression allows for the maximization of data transfer speed.

Once the data is compressed and the system has filled in the values for the predefined parameters, the applet ‘calls’ the processing script, wherein the applet and processing script are in communication via well known programming techniques. The processing script receives the signature input data and related field parameters.

The processing script stores the transmitted information in the storage database 34 on a storage medium. A unique code is assigned to the signature input data by the processing script for later identification. In one embodiment, the storage database 34 is a RDMS, Sybase ASE 11 database, although any database configuration that can store and allow the retrieval of the information is suitable. The storage medium can be a stand-alone hard disk or on the medium wherein the processing script resides. In one preferred embodiment, the processing script resides on a UNIX server. It is to be understood that any storage medium capable of storing the input data and relevant fields is suitable.

After the processing script has stored the input data and the field information, the processing script returns a URL which corresponds to a web page containing a form action command with all of the data fields and the unique code to the participant's site. The form action command is an html command that is embedded into the web page. The command enables the user to input information into the web page and submit the information. Upon submission, the form action command invokes a script that is capable of parsing the data entered into the form fields with the database and configure it for processing. In one embodiment, the form action URL is configured as “field1=value1, field2=value2 . . . signID=12345678”, wherein signID is the unique code assigned to the signature input data.

If a dispute later arises as to the validity of the transaction, the participant can initiate the data retrieval mechanism 36. The data retrieval mechanism 36 comprises a query module. The query module is a network based utility which allows the participant to access the storage medium wherein the signature input data is stored. In preferred embodiments, the participant can search the storage medium and the storage database 34 via the unique code or any of the other input fields specified for that particular signature. Further, as the participant's identification code must be submitted, a specific participant can only access signature data relevant to the specific participant's transactions. As such, there are no problems of fraud or signature misuse by participants accessing signature input of other participants. Thus, for example, if a user disputes a transaction, the participant or merchant, accesses the data retrieval mechanism and inputs, minimally the participant—identification code and unique code. The data retrieval mechanism 36 searches the database and retrieves the file corresponding to the input data. The signature pad containing the signature is presented to the merchant for verification. The merchant can forward a copy of this signature to the user, wherein the user can verify that the signature corresponds to the specific transaction via the unique code which was previously provided to the user.

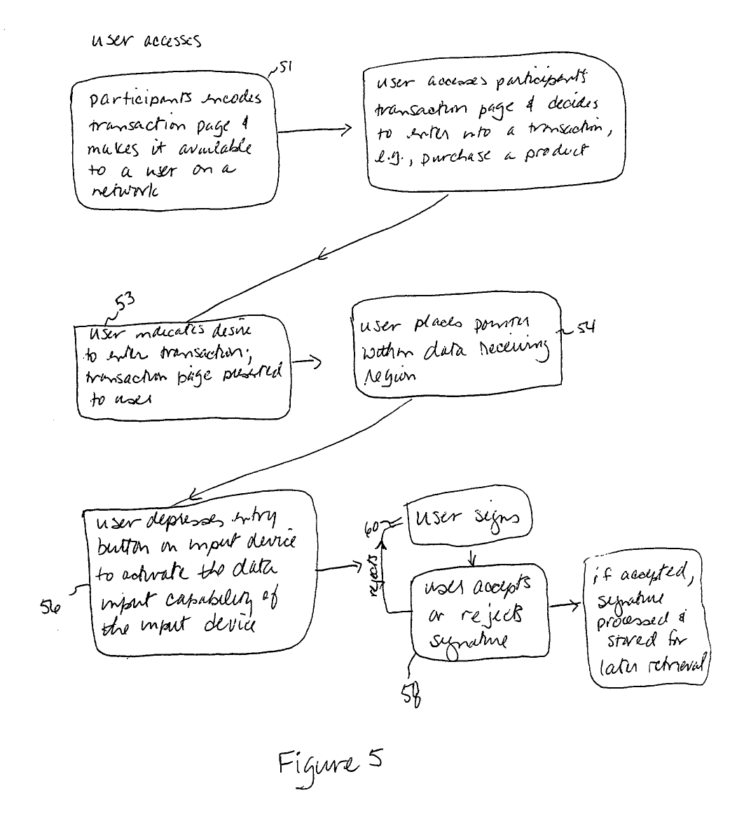

With reference to FIG. 5, a participant desiring to make a transaction available to users via a network environment, encodes a transaction page 51, for example, an HTML page, with an applet that is capable of configuring a receiving region for the acceptance of user authorization indicia. A user accesses the participant's web site or otherwise communicates with the participant via the network and decides to enter into the transaction 53, for example, to purchase a product or enter a membership agreement. Once the user has indicated a desire to enter into the transaction, the transaction page containing the applet is presented to the user 53. As the transaction page is transmitted to the user, for example, via a request from the user, the input pad is presented to the user on the user's display device. It is to be understood that in some instances, the original page that the user is viewing contains the applet such that the input pad or a signature block is included at the time the user views the page, for example, a contract. The user places the pointer within the data receiving region via the computer input device 54, such as the mouse, which is capable of placing the cursor on the signature pad. As the user places the cursor within the signature pad, the cursor is converted to a pen or pencil, thereby alerting the user that the system is capable of accepting the signature data. The user can then use the mouse to “write” within the signature pad. To write within the signature pad, the user depresses the entry member on the input device 56 and commences tracing his authorization indicia, for example, his signature, on any convenient surface, such as a mouse pad, or the table upon which the user computer 12 resides. As the user signs his name, a signature appears within the signature pad on the computer screen.

When the user has completed his signature, the user releases the mouse button and reviews the signature to determine whether it is acceptable. The user can then “submit” or “clear” the signature 58. If the user desires to reenter the signature, the user depresses the ‘clear’ button such that the signature data is erased from the data receiving region. If the user “clears” the signature, the user must then resign 60. If the user accepts the signature as entered, the user depresses the ‘submit’ button.

Once the user has submitted the authorization indicia, in some instances, the data receiving input applies a fitting algorithm to the authorization indicia, wherein the fitting algorithm is implemented upon submission of the signature. This effectively smooths the signature data such that it is more consistent with a signature produced by pen and paper. The signature data is then compressed and converted to a digital bitmap image. The processing script assigns a unique code to the user authorization data and stores the bitmap image file with the unique code in the storage database.

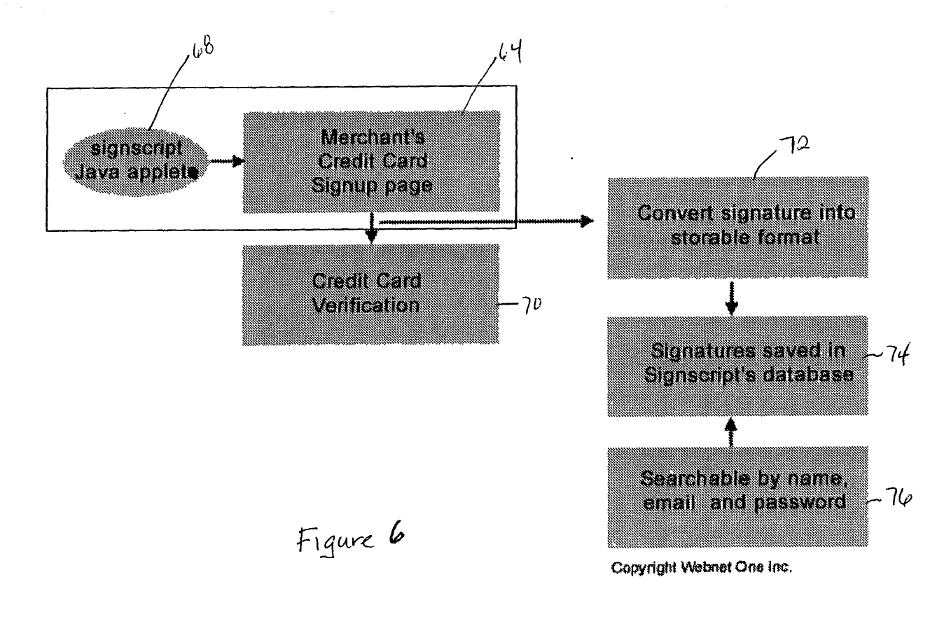

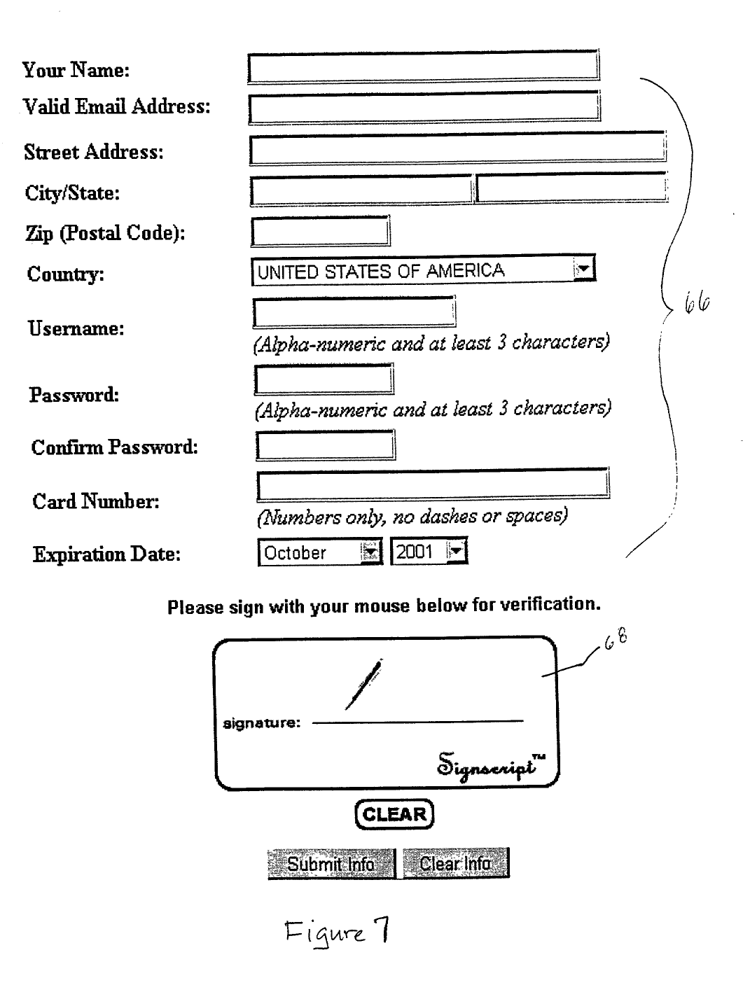

It is to be understood that the data input, storage and retrieval system can be used for any types of transactions on a network, such as the Internet. For instance, with reference to FIGS. 6 and 7, a merchant can utilize the system to conduct sales on the network and obtain a signed authorization of the transaction.

With reference to FIG. 6, in one preferred embodiment, a user accesses a merchant's web site on a network and decides to purchase products or services from the merchant. With reference to FIG. 7, once an indication is made by the user to purchase products or services, the user is presented with a transaction page, such as, an information or sign-up page 64. The information page 64 includes requests for user information 66 and an on-line signature pad 68. In some preferred embodiments, the signature pad is presented as a separate page which is accessed once the user information is entered.

To effectuate the transaction, the user must input the user information prior to the transaction. User information can include, but is not limited to, a user name, a user address, a user email address, user payment information and the like. Once the relevant information is input, to initiate the processing of the transaction, the user must sign the on-line signature pad. The user signs the signature pad and submits the signature data in the manner described above.

With reference again to FIG. 6, in embodiments of the present invention, once the user has signed the on-line signature pad and submits the signature, the merchant processes the charge for authorization 70. If the charge is authorized, the signature is converted to an acceptable format for storage 72 and stored in a database 74. In one embodiment, the signature file is correlated to some user indicia, including, but not limited to, the user's name, email address, a password or a unique code. In this manner, a merchant can later search and retrieve a signature to provide verification for a purchase 76.

A merchant can utilize the data input, storage and retrieval system by establishing an account with the system. At the time that the account is established, the merchant is assigned an identification code, PARTICIPANT_ID, and is further given the option of providing a variety of parameter information that can be associated with the merchant's signature pad as discussed above. In addition, at the time account is established, the merchant determines which parameter data is to be correlated with the signature input data. The merchant then adds the data receiving member into all files for which the merchant deserves to utilize the system.

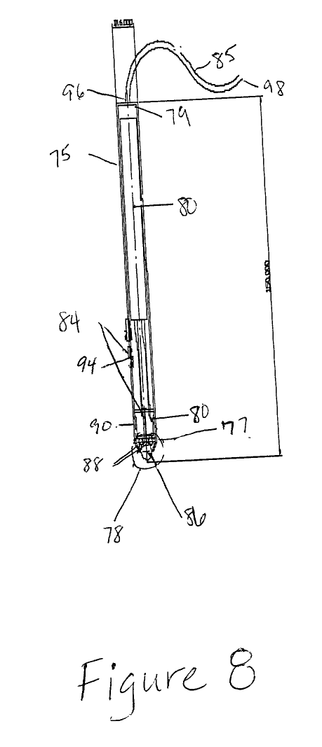

Although the above embodiments have been discussed in accordance with various equipment and software, it is to be understood that variations of the hardware are also suitable. For instance, in a specific embodiment, with reference to FIG. 8, the input device is shaped as a pen, although it performs the same functions as the standard mouse. In accordance with the embodiment of FIG. 8, the input device comprises a body 75, a mechanical sensing member 78, an optical sensing member 80, a processor 82, control buttons 84 and a coupling cable 85.

The body 75 is a hollow tube or cylinder having a first end 77 and a second end 79. In preferred embodiments, the body 75 is made from plastic or steel material, although other materials, including, but not limited to, aluminum, are also suitable.

The mechanical sensing member comprises a rub ball 86 and a plurality of rub cylinders 88. The rub ball is a ball which resides adjacent the first end 77 of the body 75. The rub ball 86 is configured to smoothly rotate or roll on a hard surface, such as a table or desk surface. The rub ball 86 is spherical in shape, although other shapes such as a hemisphere are also suitable. The rub ball is made from rubber, soft plastic, steel, metal alloys and any other suitable material that allows the rub ball to smoothly rotate.

The plurality of cylinders 88 reside adjacent to, and contact the rub ball 86. The cylinders are positioned such that the cylinders surround the rub ball. The cylinders transform the rub ball 86 movement into two dimensional coordinates, X and Y, which corresponds to the movement of the screen cursor along the X and Y axis. In one preferred embodiment, the cylinders 88 comprise a set of grid points mapped onto the surface of the cylinders 88. The map of the grid points are stored in the processor. The cylinders are cylindrical in shape, although a half moon shape would also be suitable.

The cylinders operate in conjunction with the rub ball, such that as the rub ball rotates, the cylinders rotate. In a specific embodiment, four cylinders surround the rub ball.

The optical sensing member comprises a laser generator, optical fiber and optical sensors. The generator, fiber and sensors operate in accordance with standard optical laser principles, wherein the laser generator is any standard generator that is suitable for use in combination with the input device and the optical fiber transmits the laser signal to the processor. In one specific embodiment, the optical sensors are micro fiber optical sensors.

The processor 82 is a suitable circuit board that is capable of receiving, storing and processing laser input data. The processor 82 is coupled to the optical fiber such that laser input data is transferred from the optical sensing member to the processor via the optical fiber, wherein the processor 82 transforms the analog signals received from the optical sensing member 78 into digital signals, which can be recognized by the computer. Further, the processor 82 processes the events of the input device 38, such as the left-button clicks and the right-button clicks.

The control buttons 84 are a set of buttons that operate in accordance with the operations of other computer input devices and are coupled to the processor 82. The control buttons comprise a left button 90 and a right button 94. The left button 90 allows for the control of the cursor on the computer display and the acceptance of input data from the display. The right button 94 reveals a pull down menu of control features, for example, word processing features, such as cut and paste. The control buttons 84 reside on the body 75 of the input device 38 such that the buttons 84 are accessible to a user.

The coupling cable 85 resides adjacent the second end 79 of the body 75 and includes a first end 96 and a second end 98. The first end 96 of the coupling cable 85 is connected to the processor 82, and the second end 98 can be configured as a serial slot (not shown), which can couple to the serial port of the computer. The digital signals from the processor 82 are transferred through the coupling cable 85 to the serial port of the computer.

To use the pen-shaped input device, a user signs his name on a flat surface, s.a., a table or desk, similar to the manner in which the user would use a pen. The movement of the input device is transmitted via the rub ball and the cylinders. As the rub ball is rotated, the cylinders are caused to rotate and further separate the translational path of the rub ball into two 90° directional paths. As the cylinders rotate, the grid pattern rotates. The laser beam is referenced on a starting or initial point on the grid pattern such that as the grid pattern rotates, the laser beam is moved on the grid pattern. The movement of the laser beam on the grid pattern is measured by the optical sensors and transmitted as a digital signal to the processor. The change in the placement of the laser beam on the grid pattern is computed by the processor and output to the display of the user computer via the couple cable 85.

In operation, a first user desirous of accepting authorization data via a network configures the data file requiring the authorization data with a data receiving member. A second user, in communication with the first user; s.a., on a network receives the data file of interest, for example, a contract, and reviews the file. If the user decides to accept or agree with the terms of the file, the user accesses the data receiving module. In some instances, the data receiving module is automatically presented to the second user in the document file. In other instances, the second user must depress a button that accesses the data receiving module.

If the second user decides to accept the contract and sign his name, the second user depresses the left mouse control button and places the cursor within the data receiving region. Once the user has placed the cursor within the data receiving region, the second user signs his name. If the second user is satisfied with the signature, the user depresses a submit button. If the second user is not satisfied with the signature, the second user clears the signature via a ‘clear’ button and resigns his name. The submitted authorization input is stored in a database in conjunction with identifying information such that it can later be retrieved for verification of authorization for the specific transaction.

Although this system has been described in accordance with preferred embodiments, the above embodiments are not intended to limit the invention. Indeed, the signature pad is not limited in size nor shape. As such, the signature pad can be used to create documents, such as, greeting cards, letters, emails (or portions thereof, e.g., the “re:” line), and the like, wherein the user inputs handwritten information via the input device. In this manner, personalized greetings and messages can be sent. Further, smaller signature pads can be included within and throughout on-line contracts, such that a user can initial paragraphs, pages or even changes. Thus, the signature pads can be used for any purpose that might be useful for documents written or signed by hand.

In another preferred embodiment, the signature pad is utilized with a translation system. In this embodiment, the user inputs a sample letter or symbol via a signature pad for each letter A-Z. The sample letter or symbol is stored in a database. In one embodiment, the user types a message via a keyboard. The message is then translated into the inputted data corresponding to each typed letter. In another preferred embodiment, the system will operate in conjunction with a mouse input device is in the shape of a pen and includes pen-like abilities. For example, a standard mouse is semi-oval with a large rolling ball. However, the mouse with pen-like abilities is pen shaped with a smaller rolling ball, or in some embodiments, includes a shape that allows users more control to write. At least one advantage to this mouse input device is that it allows for more accurate writing on the applet.

What is claimed is:

1. A data receiving device for accepting user indicia of authorization on a computer network having a user computer, wherein the user computer includes an input device, a display device and a pointer that defines locations on the display device, wherein the input device includes an entry button and is configured to move the pointer in a continuous path on the display device, computer, comprising:
an input device, wherein the input device is configured to control the pointer in the computer;
a data processor, the data processor further comprising:
a software applet, wherein the software applet configures an input pad comprising a data receiving region, the data receiving region being defined by a matrix grid;
a fitting algorithm, wherein the fitting algorithm is configured to smooth user indicia input into the input pad;
a storage database; and
a processing script, wherein the processing script receives the processed input user indicia and stores the user indicia in the storage database.

2. A data receiving device as claimed in claim 1, wherein the software applet is configured to receive input data from the input device.

3. A data receiving device as claimed in claim 2, wherein the input data is a handwritten signature.

4. A data receiving device as claimed in claim 1, wherein the structure of the matrix grid is defined by pixel coordinates.

5. A system for receiving and processing user indicia of authorization, on a computer network, comprising:
a user computer, wherein the user computer includes an input device, a display device and a pointer that defines locations on the display device, wherein the input device includes an entry button and is configured to move the pointer in a continuous path on the display device;
a data processor, the data processor further comprising:
a software applet, wherein the software applet configures an input pad on the display device, comprising a data receiving region, the data receiving region being defined by a matrix grid;
a fitting algorithm, wherein the fitting algorithm is configured to smooth user indicia input in the data receiving region by the user;
a storage database; and
a processing script, wherein the processing script receives the processed input user indicia and stores the indicia in the storage database.

6. A system as claimed in claim 4 further comprising a data retrieval mechanism.

7. A data receiving device as claimed in claim 4, wherein the software applet is configured to receive input data from the input device.

8. A data receiving device as claimed in claim 4, wherein the input data is a handwritten signature.

9. A method for receiving and processing user indicia of authorization on a computer network having a user computer, wherein the user computer includes an input device, a display device and a pointer that defines locations on the display device, wherein the input device includes an entry button and is configured to move the pointer in a continuous path on the display device, comprising:
presenting a user an HTML page containing an applet, wherein the applet configures an input pad having a data receiving region on the display device;
placing the pointer within the data receiving region via the input device;
depressing the entry member on the input device;
moving the pointer within the data receiving region via the input device to create user indicia of authorization within the data receiving region;
applying a fitting algorithm to the user indicia;
compressing the user indicia;
converting the compressed user indicia to a digital bitmap image;
assigning a unique code to the user indicia; and
storing the user indica in a database.
